(19) United States
(12) Patent Application Publication
(10) Pub. No.: US 2024/0364008 A1
(43) Pub. Date: Oct. 31, 2024

(54) REFLECT ARRAY

(71) Applicants: Japan Display Inc., Tokyo (JP); TOHOKU UNIVERSITY, Sendai-shi (JP)

(72) Inventors: Mitsutaka OKITA, Tokyo (JP); Shigesumi ARAKI, Tokyo (JP); Shinichiro OKA, Tokyo (JP); Daiichi SUZUKI, Tokyo (JP); Qiang CHEN, Sendai-shi (JP); Hiroyasu SATO, Sendai-shi (JP); Hideo FUJIKAKE, Sendai-shi (JP)

(73) Assignees: Japan Display Inc., Tokyo (JP); TOHOKU UNIVERSITY, Sendai-shi (JP)

(21) Appl. No.: 18/766,744

(22) Filed: Jul. 9, 2024

Related U.S. Application Data
(63) Continuation of application No. PCT/JP2023/001140, filed on Jan. 17, 2023.

(30) Foreign Application Priority Data
Jan. 24, 2022 (JP) 2022-008668

(51) Int. Cl. H01Q 3/46; H01Q 1/48

(52) U.S. Cl. CPC H01Q 3/46; H01Q 1/48

(57) ABSTRACT

A reflect array includes at least one common electrode arranged on an incident side of a radio wave, at least one bias electrode arranged to overlap a back side of the at least one common electrode, a bias signal line arranged on the back side of the at least one common electrode and connected to the at least one bias electrode, and a liquid crystal layer between the at least one common electrode and the at least one bias electrode. The at least one common electrode is at a constant potential, and a bias voltage is applied to the at least one bias electrode via the bias signal line to change the dielectric constant of the liquid crystal layer.

### CROSS-REFERENCE TO RELATED APPLICATIONS

This application is a Continuation of International Patent Application No. PCT/JP2023/001140, filed on Jan. 17, 2023, which claims the benefit of priority to Japanese Patent Application No. 2022-008668, filed on Jan. 24, 2022, the entire contents of each are incorporated herein by reference.

### FIELD

An embodiment of the present invention relates to structures of electrodes in reflect arrays that can control the scattering direction of incident waves.

### BACKGROUND

A reflect array has a function of scattering incident waves in a desired direction, and is used, for example, to scatter radio waves in an area where it is difficult for radio waves to reach (an insensitive area) in between high-rise buildings. As a reflect array, a configuration in which, for example, a main array element (dipole element) and a sub-array element (power supply-free element) and a common electrode (ground electrode) are arranged across a dielectric substrate and the sub-array element is arranged in close proximity to the main array element (for example, refer to Japanese Unexamined Patent Application Publication No. 2011-019021), and a configuration in which the array element and the common electrode (ground electrode) sandwich a dielectric substrate and the common electrode has a periodic loop shape (for example, refer to Japanese Unexamined Patent Application Publication No. 2010-226695) are disclosed.

When the portion corresponding to the dielectric substrate of the reflect array is replaced with a liquid crystal layer, the dielectric constant anisotropy of the liquid crystal material can be utilized, and the directivity of the reflected wave can be varied. To change the dielectric constant, a voltage would need to be applied to the liquid crystal layer, and a bias wiring is provided.

### SUMMARY

A reflect array in an embodiment according to the present invention includes at least one common electrode arranged on an incident side of a radio wave, at least one bias electrode arranged to overlap a back side of the at least one common electrode, a bias signal line arranged on the back side of the at least one common electrode and connected to the at least one bias electrode, and a liquid crystal layer between the at least one common electrode and the at least one bias electrode. The at least one common electrode is at a constant potential, and a bias voltage is applied to the at least one bias electrode via the bias signal line to change the dielectric constant of the liquid crystal layer.

### BRIEF DESCRIPTION OF DRAWINGS

FIG. 1A is a plan view of a reflect array according to an embodiment of the present invention.

FIG. 1B is a cross-sectional view of a reflect array according to an embodiment of the present invention.

FIG. 2A is a plan view of a unit cell constituting a reflect array according to an embodiment of the present invention.

FIG. 2B is a cross-sectional view of a unit cell constituting a reflect array according to an embodiment of the present invention.

FIG. 3A is a diagram for explaining an operation of a unit cell constituting a reflect array according to an embodiment of the present invention and shows a state in which a bias voltage is not applied to the liquid crystal layer.

FIG. 3B is a diagram for explaining an operation of a unit cell constituting a reflect array according to an embodiment of the present invention and shows a state in which a bias voltage is applied to the liquid crystal layer.

FIG. 4 is a schematic diagram showing a change in the traveling direction of scattered waves by a reflect array according to an embodiment of the present invention.

FIG. 5A is a plan view of a reflect array according to an embodiment of the present invention.

FIG. 5B is a cross-sectional view of a reflect array according to an embodiment of the present invention.

FIG. 6A is a diagram showing a configuration and an electrical state of a bias electrode of a reflect array according to an embodiment of the present invention.

FIG. 6B is a diagram showing a configuration and an electrical state of a bias electrode of a reflect array according to an embodiment of the present invention.

FIG. 6C is a diagram showing a configuration and an electrical state of a bias electrode of a reflect array according to an embodiment of the present invention.

FIG. 7A is a diagram for explaining a configuration of a unit cell constituting a reflect array according to an embodiment of the present invention and shows a circuit configuration in which a capacitor is connected to a bias electrode.

FIG. 7B is a diagram for explaining a configuration of a unit cell constituting a reflect array according to an embodiment of the present invention and shows a structure when a capacitor is connected to a bias electrode.

FIG. 8 is a diagram for explaining a configuration of a unit cell constituting a reflect array according to an embodiment of the present invention and shows a structure when a capacitor is connected to a bias electrode.

FIG. 9 is a diagram for explaining a configuration of a unit cell constituting a reflect array according to an embodiment of the present invention and shows a configuration when a coil is connected to a common electrode.

FIG. 10A is a diagram for explaining a configuration of a unit cell constituting a reflect array according to an embodiment of the present invention and shows a circuit configuration in which an inductor is connected to a bias electrode.

FIG. 10B is a diagram for explaining a configuration of a unit cell constituting a reflect array according to an embodiment of the present invention, and shows a circuit configuration in which an inductor is connected to a bias electrode.

### DESCRIPTION OF EMBODIMENTS

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

### First Embodiment

A reflect array according to the present embodiment has a structure in which a common electrode and a bias electrode are arranged across a liquid crystal layer used as a dielectric layer. The details will be described below with reference to the drawings.

### 1.1 Reflect Array

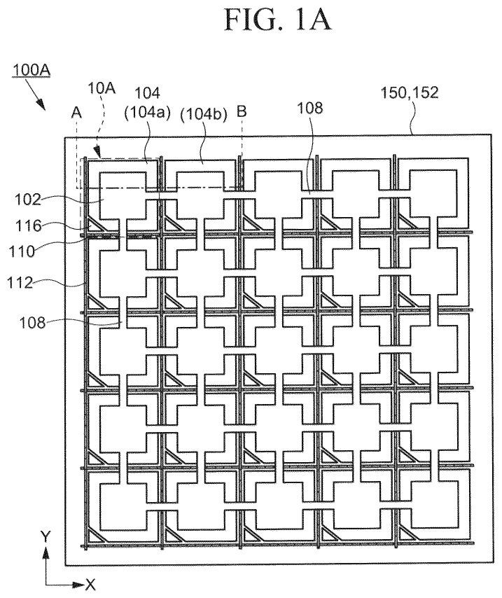

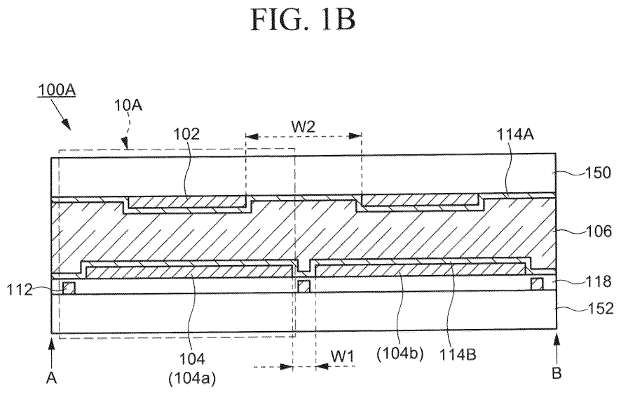

FIG. 1A shows a plan view of a reflect array 100A according to the first embodiment, and FIG. 1B shows a corresponding cross-sectional structure between A-B shown in the plan view. In the following description, both FIG. 1A and FIG. 1B shall be referred to as appropriate.

The reflect array 100A includes at least one common electrode 102, at least one bias electrode 104 and a liquid crystal layer 106 arranged between these electrodes. As shown in FIG. 1A, the common electrodes 102 are arranged in the X-axis direction and the Y-axis direction, and the bias electrodes 104 are arranged in a matrix in the X-axis direction and the Y-axis direction, corresponding to the common electrodes 102. Accordingly, the reflect array 100A has a configuration in which a plurality of common electrodes 102 and bias electrodes 104 are arranged to form a matrix, respectively. The X-axis direction and the Y-axis direction are used for explanation purposes and specifically indicate the direction shown in FIG. 1A. The X-axis direction and the Y-axis direction can also be read as a first direction and a second direction intersecting the first direction.

The common electrodes 102 are interconnected to each other by a common wiring 108. In contrast, the bias electrodes 104 are arranged so that adjacent bias electrodes 104 have a gap between them and are physically separated. The common electrode 102 is arranged on the first substrate 150 and the bias electrode 104 is arranged on the second substrate 152. The reflect array 100A is a device that scatters radio waves incident on the incident surface in a predetermined direction, where the first substrate 150 is arranged on the incident surface side and the second substrate 152 is arranged behind the incident surface. That is, the common electrode 102 is arranged on the incident surface and the bias electrode 104 is arranged across the liquid crystal layer 106 on the back side of the common electrode 102.

The reflect array 100A has a structure in which the common electrode 102, the liquid crystal layer 106 and the bias electrode 104 are arranged so that they overlap in a plan view. The reflect array 100A is arranged so that the surface on which the common electrode 102 of the first substrate 150 is arranged counter to the surface on which the bias electrode 104 of the second substrate 152 is arranged, and the liquid crystal layer 106 is arranged between them. The reflect array 100A has a basic unit of a stacked structure of a set of the common electrode 102, the liquid crystal layer 106 and the bias electrode 104 (which may also include the first substrate 150 and the second substrate 152). In the following description, this basic unit is referred to as a unit cell 10A.

The second substrate 152 is arranged with a selection signal line 110 extending in the X direction, a bias signal line 112 extending in the Y direction and a switching element 116. The switching element 116 is arranged in one-to-one correspondence with the bias electrode 104. A switching operation (on/off state) of the switching element 116 is controlled by a selection signal of the selection signal line 110, and a bias signal (bias voltage) is input from the bias signal line 112. The bias electrodes 104 are individually input with bias signals by the switching element 116. That is, the bias electrodes 104, which are arranged in a matrix, are individually input with bias signals by the switching element 116.

A first alignment film 114A is arranged on the first substrate 150 and a second alignment film 114B is arranged on the second substrate 152. The first alignment film 114A is arranged to cover the common electrode 102 and the second alignment film 114B is arranged to cover the bias electrode 104. The first alignment film 114A and the second alignment film 114B are arranged to control the alignment state of the liquid crystal layer 106. The liquid crystal layer 106 includes elongated rod-shaped liquid crystal molecules. The initial alignment state (alignment state in which no electric field is acted upon) of the liquid crystal molecules are controlled by the first alignment film 114A and the second alignment film 114B.

The alignment state of the liquid crystal molecules in the liquid crystal layer 106 is controlled by the bias electrode 104. As the bias voltage applied to the bias electrode 104 can be controlled for each unit cell 10A, the alignment state of the liquid crystal molecules in the liquid crystal layer 106 can also be controlled for each unit cell 10A. The dielectric constant of the liquid crystal layer 106 changes with the alignment state of the liquid crystal molecules. The phase of the scattered waves in the reflect array 100A changes according to the dielectric constant of the liquid crystal layer 106. Therefore, it is possible to control the direction of the scattered waves by changing the dielectric constant of the liquid crystal layer 106 in each unit cell 10A, thereby creating a phase difference in the plane of the reflect array 100A and controlling the direction in which the scattered waves travel.

The reflect array 100A scatters incident waves that are incident on the surface on which the common electrode 102 is arranged, so the common electrode 102 is also referred to as a scatterer. The unit cell 10A can also be regarded as a patch antenna with patch electrodes (common electrodes 102) on the top surface of a dielectric (liquid crystal layer 106) and reflective electrodes (bias electrodes 104) on the back surface, and the reflect array 100A can be called a reflect array antenna.

Since the bias electrode has a function as a reflector, it is preferable that the bias electrode 104 is arranged so that the distance between the bias electrode and the adjacent bias electrode is as narrow as possible. The selection signal line 110 and bias signal line 112 located on the second substrate 152 are arranged on a different layer (lower layer side) from the bias electrode 104 across the insulation layer 118. This multi-layer structure allows the bias electrodes 104 to be arranged in a narrow pitch without being affected by wiring. For example, as shown in FIG. 1B, a gap W1 between the bias electrodes 104a and the bias electrodes 104b can be narrower than an adjacent gap W2 of the common electrodes 102 (W1<W2).

Although not shown in FIG. 1A and FIG. 1B, the drive circuit for outputting the selection signal to the selection signal line 110 and the drive circuit for outputting the bias signal to the bias signal line 112 may be arranged in the second substrate 152. Input terminals may be arranged to input signals and drive power to drive these drive circuits.

### 1-2. Unit Cell

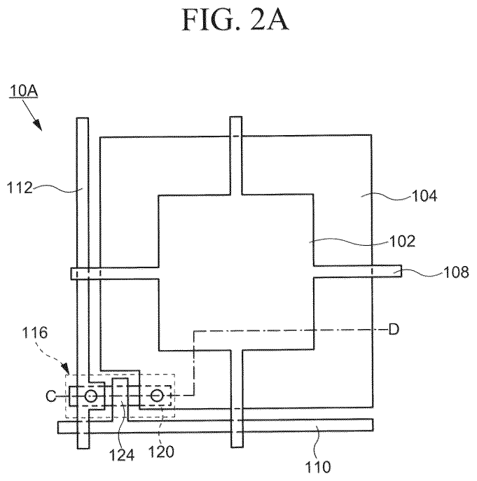

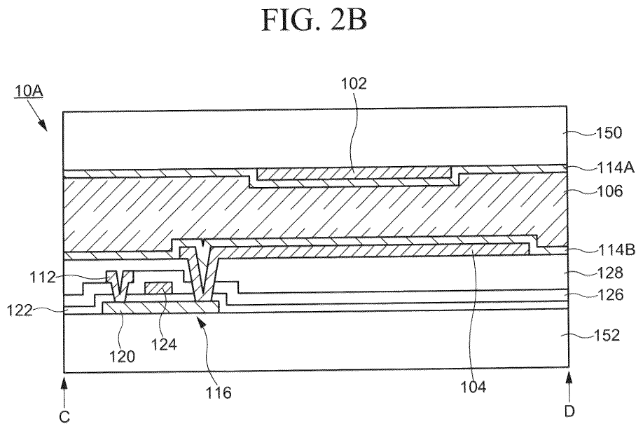

FIG. 2A and FIG. 2B show details of the unit cell 10A configuring the reflect array 100A. FIG. 2A shows a plan view of the unit cell 10A and FIG. 2B shows a cross-sectional structure between C-D shown in a plan view. As shown in FIG. 2A and FIG. 2B, the unit cell 10A is arranged so that the common electrode 102, the liquid crystal layer 106 and the bias electrode 104 overlap in a plan view.

The common electrode 102 used in the present embodiment has a shape applicable to the vertical polarization and horizontal polarization of the incident radio wave. FIG. 2A shows an example where the common electrode 102 is square. The size (vertical and horizontal dimensions) of the common electrode 102 is set according to the frequency of the targeted radio wave. The shape of the common electrode 102 is not limited to a square, and may be rectangular or have other geometric shapes.

The common electrode 102 is connected to the common wiring 108. There is no limitation on the connection structure between the common wiring 108 and the common electrode 102, for example, the common wiring 108 and the common electrode 102 are formed in the same conductive layer. The common wiring 108 is connected to a power supply circuit, which is not shown. Alternatively, the common wiring 108 is grounded or connected to a grounded wiring. As shown in FIG. 1A, the common wiring 108 connects the common electrodes 102 adjacent to each other. When the common electrodes 102 are interconnected by the common wiring 108, the common electrodes 102 arranged in a matrix have equal potential.

The bias electrode 104 is formed in a large area to function as a reflector. As shown in FIG. 2A, the bias electrode 104 has a larger area than the common electrode 102 in the unit cell 10A. The bias electrode 104 and the common electrode 102 overlap where the common electrode 102 is arranged in a region inside the bias electrode 104.

The switching element 116, the selection signal line 110 and the bias signal line 112 are arranged on the second substrate 152. The switching element 116 connects the bias signal line 112 to the bias electrode 104. The switching operation (on/off operation) of the switching element 116 is controlled by the selection signal of the selection signal line 110.

The bias electrode 104 is connected to the bias signal line 112 via the switching element 116. FIG. 2A and FIG. 2B show an example where the switching element 116 is formed by a transistor. The transistor has a structure in which a semiconductor layer 120, a gate insulating layer 122 and a gate electrode 124 are stacked. An interlayer insulating layer 126 is arranged above the gate electrode 124 and the bias signal line 112 is arranged thereon. The switching element 116 and the bias signal line 112 are filled with a planarization layer 128. The bias electrode 104 is arranged above the planarization layer 128. The bias electrode 104 is connected to the input/output terminals (source or drain) of the switching element (transistor) 116 via contact holes. The gate electrode 124 of the switching element (transistor) 116 is connected to the selection signal line 110 and the input/output terminal (source or drain) which is not connected to the bias electrode 104, is connected to the bias signal line 112.

The potential of the bias electrodes 104 is individually controlled by connecting the bias electrodes 104 to the bias signal line 112 through the switching element 116. The selection signal line 110, the bias signal line 112 and the switching element 116, which are arranged on the lower layer side of the bias electrode 104, are embedded by the planarization layer 128. As the bias electrode 104 is arranged above the planarization layer 128, the bias electrode 104 can have a large area without being affected by the selection signal line 110, the bias signal line 112 and the switching element 116. The adjacent spacing of the bias electrodes 104 arranged in a matrix can be narrowed.

The alignment state of the liquid crystal molecules in the liquid crystal layer 106 is controlled by the bias electrode 104. That is, the liquid crystal molecules in the liquid crystal layer 106 are aligned by the bias signal applied to the bias electrode 104. The bias signal is a DC voltage signal or a polarity-reversing DC voltage signal in which a positive DC voltage and a negative DC voltage are alternately reversed.

The liquid crystal layer 106 is formed of a liquid crystal material having dielectric anisotropy. For example, nematic, smectic, cholesteric and discotic liquid crystals can be used as liquid crystal materials to form the liquid crystal layer 106. The dielectric constant of the liquid crystal layer 106 changes according to the alignment state of the liquid crystal molecules. The alignment state of the liquid crystal molecules is controlled by the bias electrode 104. When incident waves are scattered in the unit cell 10A, the phase of the scattered waves changes according to the dielectric constant of the liquid crystal layer 106.

The frequency bands to which the reflect array 100A is applicable are the very high frequency (VHF), ultra-high frequency (UHF), super high frequency (SHF), tremendously high frequency (THF) and extra high frequency (EHF) bands. The alignment of the liquid crystal molecules in the liquid crystal layer 106 changes according to the bias voltage applied to the bias electrode 104, but hardly follows the frequency of the radio waves incident on the common electrode 102. These characteristics of the liquid crystal molecules allow the bias electrode 104 to change the dielectric constant of the liquid crystal layer 106 while scattering radio waves at the common electrode 102 and controlling the phase of the scattered radio waves.

The first substrate 150 is formed of glass, quartz or similar material. The second substrate 152 is formed of a dielectric material such as glass, quartz, a resin or the like. Each layer on the first substrate 150 and on the second substrate 152 is formed using the following materials. The semiconductor layer 120 is formed of a silicon semiconductor such as an amorphous silicon or a polycrystalline silicon, or an oxide semiconductor including metal oxides such as indium oxide, zinc oxide and gallium oxide. The gate insulating layer 122 and the interlayer insulating layer 126, for example, are formed of a silicon oxide film or a laminated structure of a silicon oxide film and a silicon nitride film. The selection signal line 110 and the gate electrode 124 are configured using, for example, molybdenum (Mo), tungsten (W) or an alloy of these materials. The bias signal line 112 is formed using a metallic material such as titanium (Ti), aluminum (Al) or molybdenum (Mo). For example, the bias signal line 112 is configured with a titanium (Ti)/aluminum (Al)/titanium (Ti) laminate structure or a molybdenum (Mo)/aluminum (Al)/molybdenum (Mo) laminate structure. The planarization layer 128 is formed of a resin material such as an acrylic, a polyimide or the like. The common electrode 102 and bias electrode 104 are formed from a metal film such as aluminum (Al), copper (Cu) or a transparent conductive film such as indium tin oxide (ITO).

Although not shown in FIG. 2B, the first substrate 150 and the second substrate 152 are arranged with a gap between them and are attached together by a sealant. The liquid crystal layer 106 is sealed within the region enclosed by the first substrate 150, the second substrate 152 and the sealant. The gap between the first substrate 150 and the second substrate 152 is roughly 20 μm to 100 μm, for example, 50 μm. Although not shown, spacers may be arranged between the first substrate 150 and the second substrate 152 to keep the gap constant.

As shown in FIG. 1A and FIG. 1B, since the common electrodes 102 arranged in a matrix are interconnected by the common wiring 108, and the bias electrodes 104 are connected to the bias signal line 112 via the switching element 116 to enable the potential to be individually controlled, the dielectric constant of the liquid crystal layer 106 can be changed for each unit cell 10A. Thereby, it is possible to control the phase of the scattered waves for each of the 10A unit cells.

### 1-3. Operation of Unit Cell

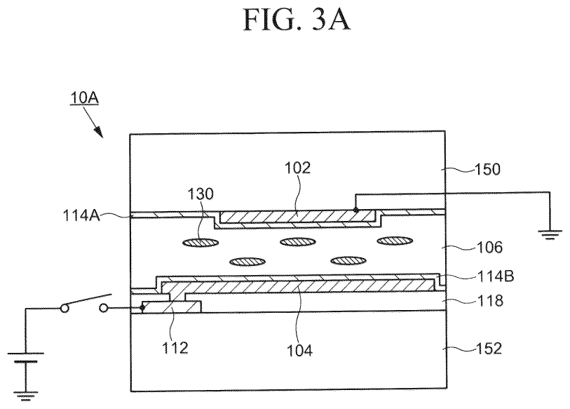

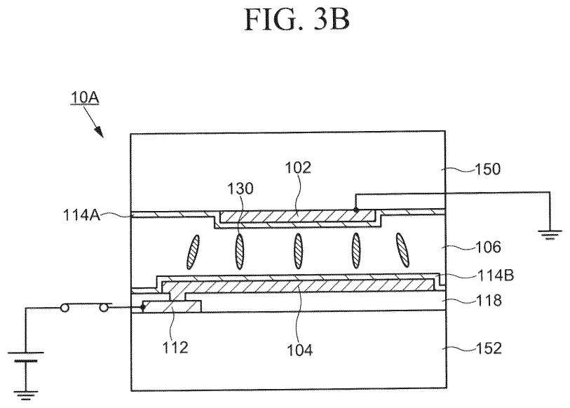

FIG. 3A and FIG. 3B show the operation of the unit cell 10A. FIG. 3A and FIG. 3B show the example where the first alignment film 114A and the second alignment film 114B are horizontally aligned films. FIG. 3A shows a state in which the bias voltage is not applied to the bias electrode 104. In other words, FIG. 3A shows a state in which a DC voltage is not applied to the bias electrode 104 at a level that alters the alignment state of the liquid crystal molecules. Hereinafter, this state is referred to as the “first state”. FIG. 3A shows that in the first state, the long axes of a liquid crystal molecule 130 are aligned horizontally (initial alignment state) due to the alignment regulating force of the first alignment film 114A and the second alignment film 114B. In other words, the first state is a state in which the long axis direction of the liquid crystal molecules 130 is aligned horizontally to the surfaces of the common electrode 102 and the bias electrode 104.

FIG. 3B shows a state in which the bias voltage is applied to the bias electrode 104 at a voltage level that alters the alignment state of the liquid crystal molecules 130. Hereinafter, this state is referred to as the “second state”. In the second state, the long axis direction of the liquid crystal molecules 130 aligns perpendicularly to the surfaces of the common electrode 102 and the bias electrode 104 under the influence of the electric field generated by the bias voltage. The angle at which the long axis of the liquid crystal molecules 130 aligns can be controlled by the magnitude of the bias signal applied to the bias electrode 104, and can be aligned at an angle between horizontal and vertical.

When the liquid crystal molecules 130 have positive dielectric anisotropy, the apparent dielectric constant is larger in the second state (FIG. 3B) relative to the first state (FIG. 3A). When the liquid crystal molecules 130 have negative dielectric anisotropy, the apparent dielectric constant is smaller in the second state (FIG. 3B) with respect to the first state (FIG. 3A). The liquid crystal layer 106 formed with liquid crystals having dielectric anisotropy can be regarded as a variable dielectric layer. It is possible to control the unit cell 10A to delay (or not) the phase of the radio waves scattered by the common electrode 102 by using the dielectric anisotropy of the liquid crystal layer 106.

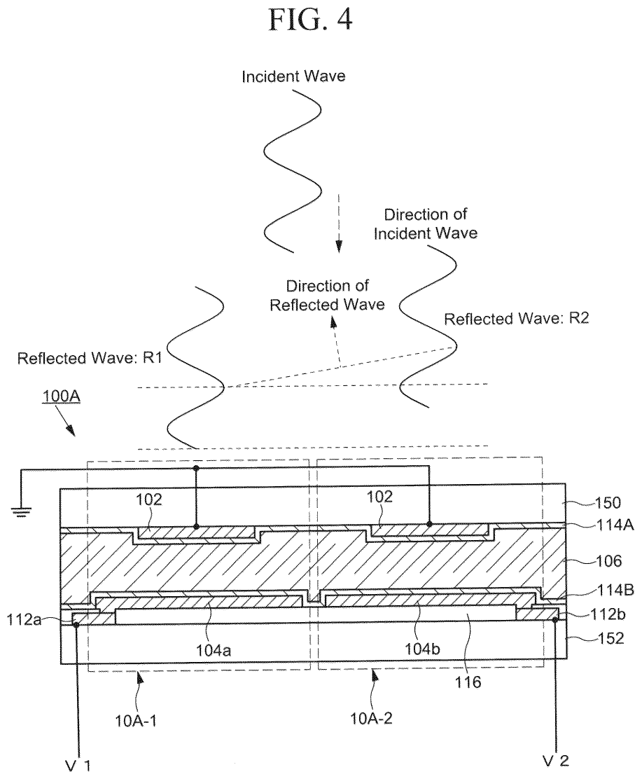

FIG. 4 schematically shows a mode in which the direction of travel of the reflected wave is changed by a first unit cell 10A-1 and a second unit cell 10A-2. A bias signal V1 is applied to the bias electrode 104a of the first unit cell 10A-1 from the bias signal line 112a, and a bias signal V2 is applied to the bias electrode 104b of the second unit cell 10A-2 from the bias signal line 112b. Here, the voltage levels of the bias signal V1 and bias signal V2 are different (V1≠V2). The common electrode 102 of the first unit cell 10A-1 and the second unit cell 10B-1 are grounded.

FIG. 4 schematically shows that the phase change of the scattered wave by the second unit cell 10A-2 is larger than that of the first unit cell 10A-1, when radio waves are incident on the first unit cell 10A-1 and the second unit cell 10A-2 at the same phase, due to different bias signals (V1≠V2) being applied to the first unit cell 10A-1 and the second unit cell 10A-2. As a result, the phase of the scattered wave R1 scattered in the first unit cell 10A-1 and the phase of the scattered wave R2 scattered in the second unit cell 10A-2 are different (the phase of the scattered wave R2 is more advanced than the phase of the scattered wave R1 in FIG. 4) and the apparent direction of the scattered wave changes obliquely.

As shown in FIG. 4, it is possible for the reflect array 100A to differ the phase of the scattered wave with respect to the incident wave between the first unit cell 10A-1 and the second unit cell 10A-2. FIG. 4 schematically shows two-unit cells, but in practice the direction of the scattered waves can be controlled in any direction without changing the direction of the reflect array 100A by controlling the unit cells 10A, which are arranged in a matrix, individually. Since the plurality of common electrodes 102 arranged on the reflective surface of the reflect array 100A are held at a constant potential (for example, at a ground potential), and the bias electrodes 104a, 104b and the bias signal lines 112a, 112b, which apply a bias voltage to the liquid crystal layer 106, are arranged behind the common electrodes 102, it is possible to avoid the influence of the electric field generated by the bias signal lines 112a and 112b on the front side of the reflect array 100A.

As described above, since the reflect array 100A of the present embodiment has a common electrode 102 arranged on the incident surface of the radio wave and is held at a constant potential, it is possible to prevent the electric field from being disturbed by the bias signal line 112 to which the bias voltage is applied, and the direction of the scattered waves can be accurately controlled.

### Second Embodiment

The present embodiment shows an example of a reflect array in which the structure of the common electrode differs from the first embodiment. The following description will focus on the parts that differ from the first embodiment, and duplicated parts will be omitted as appropriate.

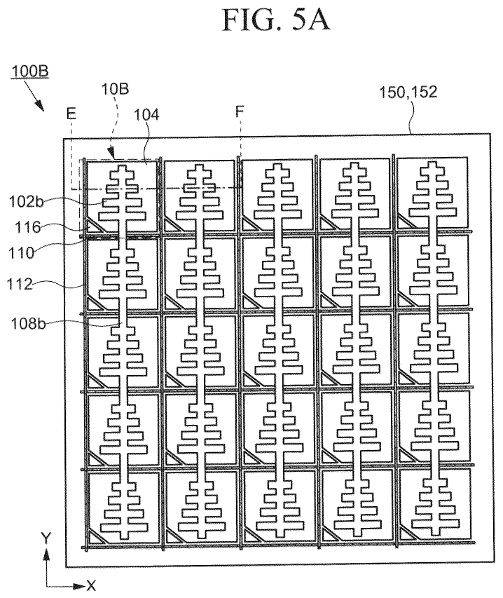

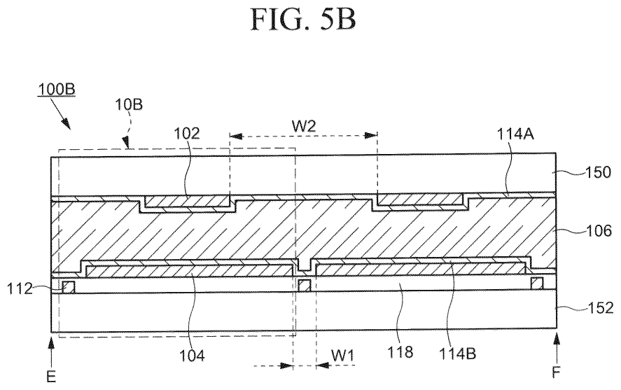

FIG. 5A shows a plan view of a reflect array 100B of the second embodiment, and FIG. 5B shows a cross-sectional structure corresponding to A-B shown in a plan view. The reflect array 100B has a first substrate 150 and a second substrate 152, and a structure in which a common electrode 102B, a liquid crystal layer 106 and a bias electrode 104 are stacked between these two substrates.

The reflect array 100B has the configuration of an array of multiple resonance unit cells 10B. The common electrode 102b of the multiple resonance unit cell 10B has a different shape compared to that of the unit cell 10A shown in the first embodiment. The common electrode 102b has a structure in which a plurality of parallel dipoles is arranged. The plurality of parallel dipoles has different lengths and are made to have different resonance frequencies. FIG. 5A shows a form in which four parallel dipoles of different lengths are arranged along the Y-axis direction. The length and number of parallel dipoles are arbitrary and can be set accordingly.

The common electrode 102b is connected by a common wiring 108b. In the first embodiment, the common wiring 108 is arranged in both the X-axis and Y-axis directions, but in this embodiment, the common wiring 108b is arranged only in the Y-axis direction that intersects the parallel dipole. Although not shown in FIG. 5A, the common wiring 108b may be interconnected in the outer regions where the multiple resonance unit cells 10B are arranged. The common wiring 108b is supplied with a constant potential (for example, a ground potential).

According to the present embodiment, the common electrode 102b can be configured with the plurality of parallel dipoles to form the multiple resonance unit cell 10B. The reflect array 100B according to the present embodiment is the same as the reflect array 100A according to the first embodiment, except that the form of the common electrode 102b is different, and the same effects can be obtained. Furthermore, the reflect array 100B according to the present embodiment can significantly improve the bandwidth, phase range and loss by being configured with the multiple resonance unit cell 10B.

### Third Embodiment

The present embodiment is described in detail with regard to the configuration of the bias electrode 104. The following description will focus on the parts that differ from the first and second embodiments, and duplicated parts will be omitted as appropriate.

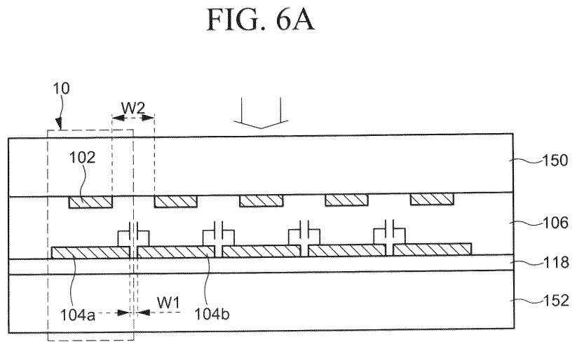

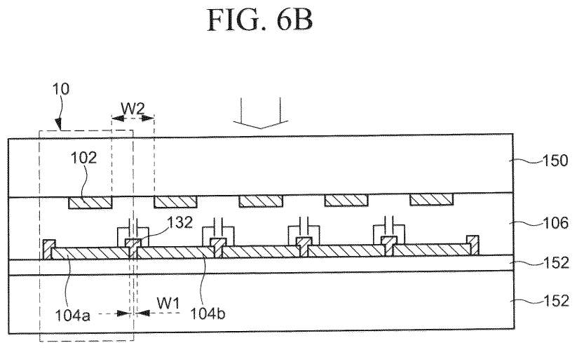

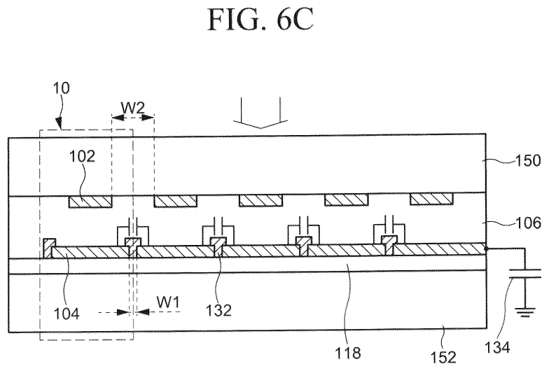

FIG. 6A shows a cross-sectional schematic structure of a reflect array 100. As shown in FIG. 6A, a first substrate 150 with a common electrode 102 and a second substrate 152 with a bias electrode 104 are arranged counter to each other, and a liquid crystal layer 106 is arranged between them. The reflect array 100 is preferred so that the bias electrode 104, which is divided for each unit cell 10, is regarded as one continuous conductor plate at high frequencies, as the bias electrode 104 functions as a reflector.

Then, as shown in FIG. 6A, a gap W1 between a bias electrode 104a and an adjacent bias electrode 104b is narrowed to form an apparent capacitor, so that a capacitive coupling is formed. The gap W1 is preferably less than 5 μm, for example, 1 μm. As shown in FIG. 6B, an insulating member 132 may be arranged between the bias electrode 104a and the bias electrode 104b to adjust the capacitance. The insulating member 132 is preferably made of an insulating material having a dielectric constant higher than the dielectric constant of the liquid crystal. It is preferable to use the insulating material with a relative dielectric constant of 3 or more as the insulating member 132, for example, silicon nitride, aluminum oxide, hafnium oxide, hafnium silicate, tantalum oxide or the like. These dielectric materials have a relative dielectric constant of 7 to 18, which is higher than that of liquid crystal materials. Therefore, the bias electrodes can be capacitively coupled to each other more effectively than the structure shown in FIG. 6A.

As shown in FIG. 6C, the bias electrodes may be capacitively coupled to each other as shown in FIG. 6A or FIG. 6B and further grounded via a capacitor 134 at the termination.

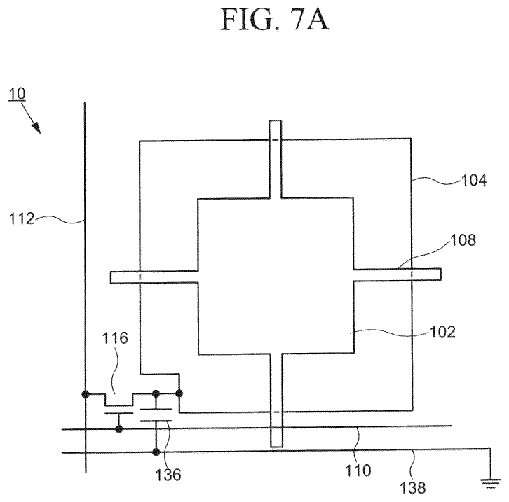

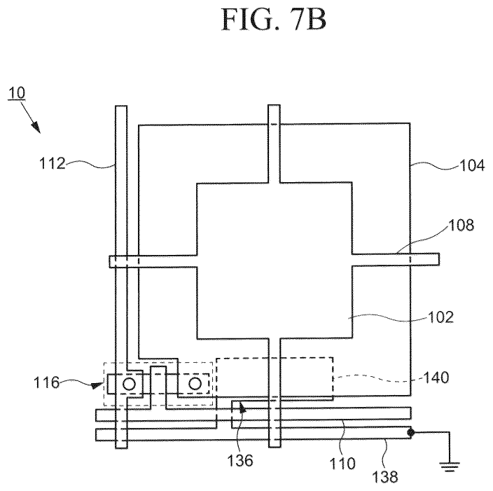

FIG. 7A shows a circuit configuration of the unit cell 10. As shown in FIG. 7A, the bias electrode 104 is connected to the bias signal line 112 via the switching element 116, and in addition, the capacitor 136 may be connected in parallel between the bias electrode 104 and the switching element 116 and grounded via a capacitor 136. For example, the common wiring 138 may be grounded, and the capacitor 136 may be connected between the bias electrode 104 and the common wiring 138.

FIG. 7B shows an embodiment of the circuit configuration shown in FIG. 7A. As shown in FIG. 7B, the capacitor 136 can be formed by providing the bias electrode 104 and a capacitor electrode 140 overlapping across an insulation layer not shown. It is possible to make the circuit configuration shown in FIG. 7A by connecting the capacitor electrode 140 to the common wiring 138.

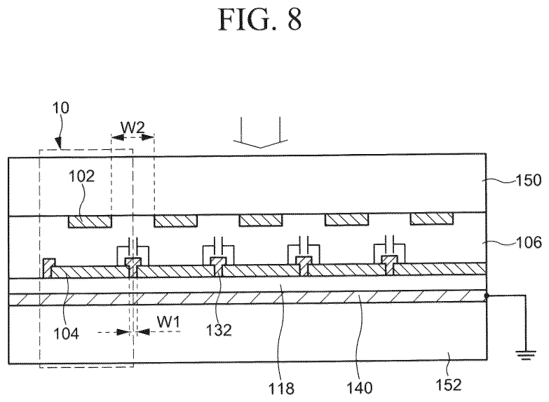

As shown in a cross-sectional view of the unit cell 10 in FIG. 8, the capacitor electrode 140 may be arranged on the lower layer of the bias electrode 104, spread over the entire surface of the second substrate 152 via the insulation layer 118, and the capacitor electrode 140 may be grounded.

According to this embodiment, it is possible to improve a gain of the reflect array 100 by capacitively coupling the plurality of bias electrodes 104 and making them continuous reflectors in the high-frequency sense. The configuration shown in the present embodiment can be combined as appropriate with the reflect array 100A shown in the first embodiment and the reflect array 100B shown in the second embodiment.

### Fourth Embodiment

The present embodiment is described in detail with regard to the configuration of a common electrode 102. The following description will focus on the parts that differ from the first and second embodiments, and duplicated parts will be omitted as appropriate.

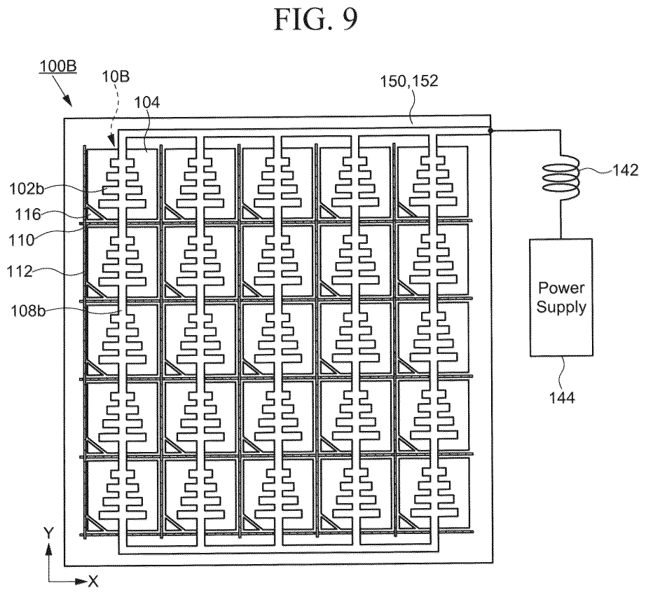

FIG. 9 shows a plan view of a reflect array 100B. As shown in FIG. 9, a common electrode 102b connected by a common wiring 108b extending in the Y-axis direction may be connected at the end by a common wiring 108a extending in the X-axis direction and connected to a power supply circuit 144. A coil 142 is preferably connected in series between the common wiring 108b and a power supply circuit 144. The power supply circuit 144 is used to control the common electrode 102b to a predetermined potential. The coil 142 between the common electrode 102b and the power supply circuit 144 can cut off high frequencies and prevent circuit breakdowns. FIG. 9 shows the common electrode 102b of the reflect array 100B, and a similar configuration can be applied to the reflect array 100A shown in the first embodiment.

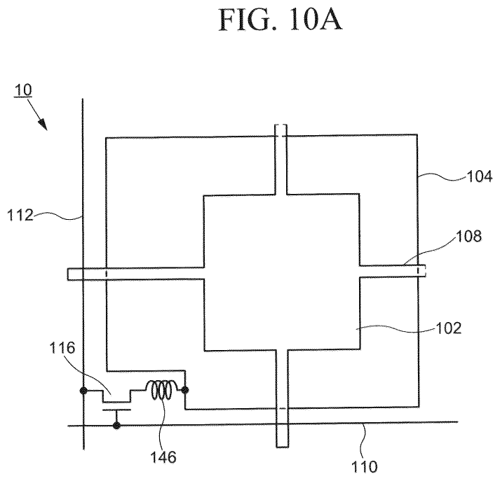

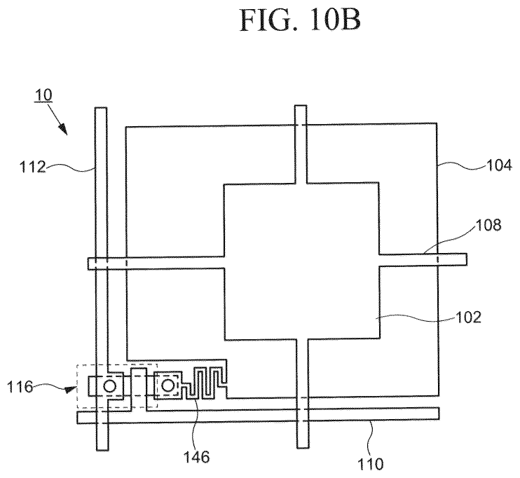

FIG. 10A shows a circuit configuration of the unit cell 10. As shown in FIG. 10A, an inductor 146 may be connected in series between a bias electrode 104 and a switching element 116. The inductor 146 can be formed using a conductive film forming the bias electrode 104, as shown in FIG. 10B. This configuration can prevent high-frequency currents from flowing into the switching element 116 and a bias signal line 112, thereby preventing failures of the switching element 116 and the control circuit.

The configuration shown in the present embodiment can be combined as appropriate with the reflect array 100A shown in the first embodiment and the reflect array 100B shown in the second embodiment.

The various configurations of the reflect array illustrated as embodiments of the present invention can be combined as appropriate as long as they do not contradict each other. Based on the reflect array disclosed in the present invention and the drawings, any addition, deletion or design change of configuration elements, or any addition, omission or change of conditions of the process, made by a person skilled in the art as appropriate, is also included in the scope of the invention, as long as it has the gist of the invention.

It is understood that other advantageous effects different from the advantageous effects resulting from the mode of embodiment disclosed herein, but which are obvious from the description herein or which can be easily foreseen by those skilled in the art, are naturally brought about by the present invention.

What is claimed is:

1. A reflect array, comprising:
at least one common electrode arranged on an incident side of a radio wave;
at least one bias electrode arranged to overlap a back side of the at least one common electrode;
a bias signal line arranged on the back side of the at least one common electrode and connected to the at least one bias electrode; and
a liquid crystal layer between the at least one common electrode and the at least one bias electrode,
wherein
the at least one common electrode is at a constant potential, and
a bias voltage is applied to the at least one bias electrode via the bias signal line to change the dielectric constant of the liquid crystal layer.

2. The reflect array according to claim 1, wherein the at least one common electrode has a rectangular pattern or a plurality of parallel dipole-patterns of different mutual lengths.

3. The reflect array according to claim 1, wherein the at least one common electrode comprises a plurality of common electrodes and the at least one bias electrode comprises a plurality of bias electrodes, and
wherein the plurality of common electrodes and the plurality of bias electrodes are arranged in a matrix.

4. The reflect array according to claim 3, further comprising a common wiring interconnecting the plurality of common electrodes.

5. The reflect array according to claim 3, wherein a spacing between the plurality of bias electrodes is narrower than a spacing between the plurality of common electrodes.

6. The reflect array according to claim 3, further comprising an insulating member filled in between the plurality of bias electrodes.

7. The reflect array according to claim 3, wherein the plurality of bias electrodes are grounded via a capacitor.

8. The reflect array according to claim 1, wherein the at least one bias electrode is connected to the bias signal line via a switching element.

9. The reflect array according to claim 8, wherein the at least one bias electrode is grounded via a capacitor between the at least one bias electrode and the switching element.

10. The reflect array according to claim 8, further comprising a ground electrode which is grounded,
wherein the ground electrode overlaps the at least one bias electrode via an insulating layer.

11. The reflect array according to claim 1, further comprising a power supply circuit that applies a predetermined voltage to the at least one common electrode,
wherein the inductor is connected between the at least one common electrode and the power supply circuit.

12. The reflect array according to claim 8, further comprising an inductor connected between the at least one bias electrode and the switching element.
